(19) United States
(12) Patent Application Publication
(10) Pub. No.: US 2024/0381156 A1
(43) Pub. Date: Nov. 14, 2024

(54) WIRELESS COMMUNICATION METHOD AND APPARATUS, AND COMMUNICATIONS DEVICE

(71) Applicant: GUANGDONG OPPO MOBILE TELECOMMUNICATIONS CORP., LTD., Dongguan (CN)

(72) Inventors: Yang XU, Dongguan (CN); Jingran CHEN, Dongguan (CN)

(21) Appl. No.: 18/781,568

(22) Filed: Jul. 23, 2024

Related U.S. Application Data
(63) Continuation of application No. PCT/CN2022/076092, filed on Feb. 11, 2022.

(51) Int. Cl. H04W 24/10; H04W 24/02; H04W 28/02

(52) U.S. Cl. CPC H04W 24/10; H04W 24/02; H04W 28/0268

(57) ABSTRACT

Embodiments of this application provide a wireless communication method and apparatus, and a communications device. The method includes: measuring, by a first network device, a first rate of a first group, where the first group includes at least two terminal devices that participate in a first group service, the first rate is formed by rates of at least two first connections, the at least two first connections include first connections for the at least two terminal devices, and the first connection is used for transmitting data of the first group service.

### CROSS-REFERENCE TO RELATED APPLICATIONS

This application is a continuation of International Application No. PCT/CN2022/076092, filed on Feb. 11, 2022, the disclosure of which is hereby incorporated by reference in its entirety.

### TECHNICAL FIELD

Embodiments of this application relate to the technical field of mobile communications, and in particular, to a wireless communication method and apparatus, and a communications device.

### BACKGROUND

An application server for group services such as federated learning interacts with a plurality of terminal devices through a 5G system to transmit data, which allows the plurality of participants to perform the group services without sharing data, thereby technically breaking down data silos. However, such a service manner requires mobilization of a plurality of terminal devices, which consume communication resources. If the application server is allowed to call wireless resources of the plurality of terminal devices without limitation, normal operation of other terminal devices or other services is inevitably affected.

### SUMMARY

Embodiments of this application provide a wireless communication method and apparatus, and a communications device.

The wireless communication method provided in this embodiment of this application includes:
measuring, by a first network device, a first rate of a first group, where the first group includes at least two terminal devices that participate in a first group service, the first rate is formed by rates of at least two first connections, the at least two first connections include first connections for the at least two terminal devices, and the first connection is used for transmitting data of the first group service.

The wireless communication method provided in this embodiment of this application includes:
transmitting, by a first terminal device, a first message to a second network device, where the first message carries fourth indication information, the fourth indication information is used for instructing the first terminal device to join a first group and/or participate in a first group service, and the first group includes at least two terminal devices that participate in the first group service.

The wireless communication method provided in this embodiment of this application includes:
receiving, by a second network device, a first message transmitted by a first terminal device, where the first message carries fourth indication information, the fourth indication information is used for instructing the first terminal device to join a first group and/or participate in a first group service, and the first group includes at least two terminal devices that participate in the first group service.

The wireless communication method provided in this embodiment of this application includes:
receiving, by the third network device, a second message transmitted by a second network device, where the second message includes second information, the second information is at least used for control of a first rate, the first rate is formed by rates of at least two first connections, the at least two first connections include first connections for the at least two terminal devices in a first group, the first group includes at least two terminal devices that participate in a first group service, and the first connection is used for transmitting data of the first group service.

The wireless communications apparatus provided in this embodiment of this application includes:
a measurement module, configured to measure a first rate of a first group, where the first group includes at least two terminal devices that participate in a first group service, the first rate is formed by rates of at least two first connections, the at least two first connections include first connections for the at least two terminal devices, and the first connection is used for transmitting data of the first group service.

The wireless communications apparatus provided in this embodiment of this application includes:
a first transmitting module, configured to transmit a first message to a second network device, where the first message carries fourth indication information, the fourth indication information is used for instructing the first terminal device to join a first group and/or participate in a first group service, and the first group includes at least two terminal devices that participate in the first group service.

The wireless communications apparatus provided in this embodiment of this application includes:
a second receiving module, configured to receive a first message transmitted by a first terminal device, where the first message carries fourth indication information, the fourth indication information is used for instructing the first terminal device to join a first group and/or participate in a first group service, and the first group includes at least two terminal devices that participate in the first group service.

The wireless communications apparatus provided in this embodiment of this application includes:
a third receiving module, configured to receive a second message transmitted by a second network device, where the second message includes second information, the second information is at least used for control of a first rate, the first rate is formed by rates of at least two first connections, the at least two first connections include first connections for the at least two terminal devices in a first group, the first group includes at least two terminal devices that participate in a first group service, and the first connection is used for transmitting data of the first group service.

The communications device provided in this embodiment of this application may be a terminal device in foregoing solutions or a network device in foregoing solutions, and the communications device includes a processor and a memory. The memory is configured to store a computer program, and the processor is configured to invoke and run the computer program stored in the memory, to execute the foregoing wireless communication method.

A chip provided in this embodiment of this application is configured to implement the foregoing wireless communication method.

Specifically, the chip includes a processor, configured to invoke a computer program from a memory and run the computer program, to cause a device on which the chip is installed to execute the foregoing wireless communication method.

A computer-readable storage medium provided in this embodiment of this application is configured to store a computer program, and the computer program causes a computer to execute the foregoing wireless communication method.

A computer program product provided in this embodiment of this application includes computer program instructions, and the computer program instructions cause a computer to execute the foregoing wireless communication method.

According to a computer program provided in this embodiment of this application, when the computer program runs on a computer, the computer executes the foregoing wireless communication methods.

### BRIEF DESCRIPTION OF DRAWINGS

The accompanying drawings described herein are used to provide a further understanding of this application, and constitute a part of this application. Schematic embodiments of this application and descriptions thereof are used to explain this application, and do not constitute an improper limitation of this application. In the accompanying drawings:

FIG. 1 is a schematic diagram of an application scenario according to an embodiment of this application.

FIG. 2 is a schematic diagram of an application scenario according to an embodiment of this application.

FIG. 3 is a schematic diagram of an application scenario according to an embodiment of this application.

FIG. 4 is a schematic diagram of an application scenario according to an embodiment of this application.

FIG. 5 is an optional schematic flowchart of a wireless communication method according to an embodiment of this application.

FIG. 6 is an optional schematic flowchart of a wireless communication method according to an embodiment of this application.

FIG. 7 is an optional schematic flowchart of a wireless communication method according to an embodiment of this application.

FIG. 8 is an optional schematic flowchart of a wireless communication method according to an embodiment of this application.

FIG. 9 is an optional schematic flowchart of a wireless communication method according to an embodiment of this application.

FIG. 10 is an optional schematic flowchart of a wireless communication method according to an embodiment of this application.

FIG. 11 is an optional schematic flowchart of a wireless communication method according to an embodiment of this application.

FIG. 12 is an optional schematic flowchart of a wireless communication method according to an embodiment of this application.

FIG. 13 is an optional schematic flowchart of a wireless communication method according to an embodiment of this application.

FIG. 14 is an optional schematic flowchart of a wireless communication method according to an embodiment of this application.

FIG. 15 is an optional schematic flowchart of a wireless communication method according to an embodiment of this application.

FIG. 16 is an optional schematic structural diagram of a wireless communications apparatus according to an embodiment of this application.

FIG. 17 is an optional schematic structural diagram of a wireless communications apparatus according to an embodiment of this application.

FIG. 18 is an optional schematic structural diagram of a wireless communications apparatus according to an embodiment of this application.

FIG. 19 is an optional schematic structural diagram of a wireless communications apparatus according to an embodiment of this application.

FIG. 20 is a schematic structural diagram of a communications device according to an embodiment of this application.

FIG. 21 is a schematic structural diagram of a chip according to an embodiment of this application.

FIG. 22 is a schematic block diagram of a communications system according to an embodiment of this application.

### DESCRIPTION OF EMBODIMENTS

The following describes the technical solutions in the embodiments of this application with reference to the accompanying drawings in the embodiments of this application. Apparently, the described embodiments are some rather than all of the embodiments of this application. All other embodiments obtained by persons of ordinary skill in the art based on embodiments of this application without creative efforts fall within the protection scope of this application.

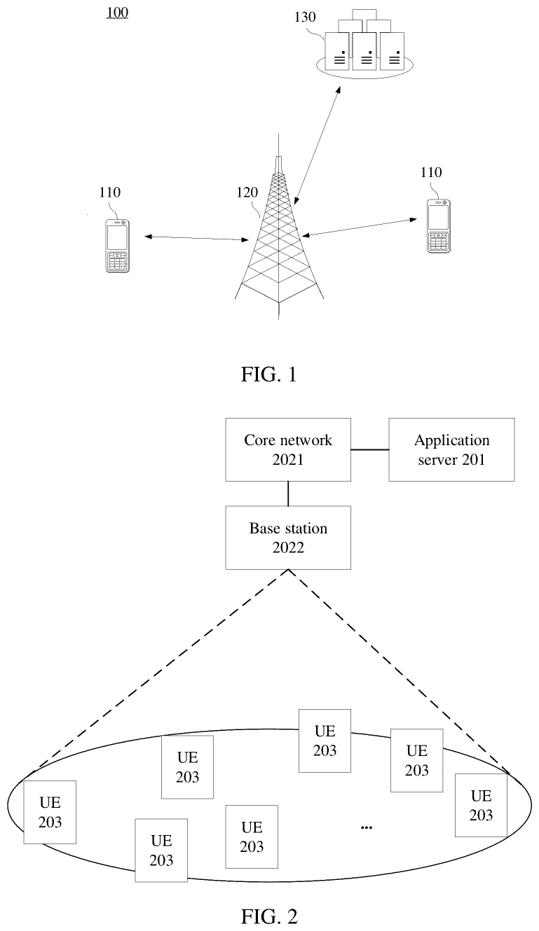

FIG. 1 is a schematic diagram of an application scenario according to an embodiment of this application.

As shown in FIG. 1, a communications system 100 may include terminal devices 110 and a network device 120. The network device 120 may communicate with the terminal devices 110 by using air interfaces. Multi-service transmission is supported between the terminal devices 110 and the network device 120.

It should be understood that the communications system 100 is merely used as an example for description in this embodiment of this application, but this embodiment of this application is not limited thereto. That is, the technical solutions in embodiments of this application may be applied to various communications systems, for example, a long term evolution (LTE) system, an LTE time division duplex (TDD) system, a universal mobile telecommunication system (UMTS), an internet of things (IoT) system, a narrow band internet of things (NB-IoT) system, an enhanced machine-type communications (eMTC) system, a 5G communications system (also referred to as a new radio (NR) communications system), or a future communications system.

In the communications system 100 shown in FIG. 1, the network device 120 may be an access network device that communicates with the terminal devices 110. The access network device may provide communication coverage for a specific geographical area, and may communicate with a terminal device 110 (for example, a UE) located in the coverage area.

The network device 120 may be an evolved NodeB (Evolutional Node B, eNB or eNodeB) in a long term evolution (LTE) system, or a next generation radio access network (NG RAN) device, or a base station (gNB) in an NR system, or a wireless controller in a cloud radio access network (CRAN). Alternatively, the network device 120 may be a relay station, an access point, a vehicle-mounted device, a wearable device, a hub, a switch, a bridge, a router, a network device in a future evolved public land mobile network (PLMN), or the like.

The terminal device 110 may be any terminal device, which includes but is not limited to a terminal device that is connected to the network device 120 or another terminal device by using a wired or wireless connection.

For example, the terminal device 110 may be an access terminal, a UE, a subscriber unit, a subscriber station, a mobile station, a mobile console, a remote station, a remote terminal, a mobile device, a user terminal, a terminal, a wireless communications device, a user agent, or a user apparatus. The access terminal may be a cellular phone, a cordless phone, a session initiation protocol (SIP) phone, an IoT device, a satellite handheld terminal, a wireless local loop (WLL) station, a personal digital assistant (PDA), a handheld device with a wireless communication function, a computing device, another processing device, a vehicle-mounted device, a wearable device, a terminal device in a 5G network, a terminal device in a future evolved network, or the like that is connected to a wireless modem.

The wireless communications system 100 may further include a core network device 130 that communicates with a base station. The core network device 130 may be a 5G core network (5GC) device, for example, an access and mobility management function (AMF), for another example, an authentication server function (AUSF), for another example, a user plane function (UPF), or for another example, a session management function (SMF). Optionally, the core network device 130 may alternatively be an evolved packet core (EPC) device of an LTE network, for example, a session management function+core packet gateway SMF+PGW-C) device. It should be understood that the SMF+PGW-C may implement both a function that can be implemented by an SMF and a function that can be implemented by a PGW-C. In a network evolution process, the foregoing core network device may also be called another name, or a new network entity may be formed by dividing a function of the core network, which is not limited in this embodiment of this application.

Communication between functional units in the communications system 100 may be further implemented by establishing a connection through a next generation (NG) interface.

For example, the terminal device establishes an air interface connection to an access network device through a Uu interface, to transmit user plane data and control plane signaling. The terminal device may establish a control plane signaling connection to an AMF through an NG interface 1 (N1 for short). The access network device, for example, a next-generation radio access base station (gNB), may establish a user plane data connection to a UPF through an NG interface 3 (N3 for short). The access network device may establish a control plane signaling connection to the AMF through an NG interface 2 (N2 for short). The UPF may establish a control plane signaling connection to an SMF through an NG interface 4 (N4 for short). The UPF may exchange user plane data with a data network through an NG interface 6 (N6 for short). The AMF may establish a control plane signaling connection to the SMF through an NG interface 11 (N11 for short). The SMF may establish a control plane signaling connection to a PCF through an NG interface 7 (N7 for short).

FIG. 1 exemplarily shows a base station, a core network device, and two terminal devices. Optionally, the wireless communications system 100 may include a plurality of base station devices, and a coverage area of each base station may include another number of terminal devices. This is not limited in this embodiment of this application.

It should be noted that FIG. 1 is only an example of a system to which this application is applicable. Certainly, the method described in this embodiment of this application may be further applicable to another system. In addition, the terms “system” and “network” may often be used interchangeably in this specification. In this specification, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects. It should be understood that, the “indication” mentioned in embodiments of this application may be a direct indication or an indirect indication, or indicate an association. For example, if A indicates B, it may mean that A directly indicates B, for example, B may be obtained from A. Alternatively, it may mean that A indicates B indirectly, for example, A indicates C, and B may be obtained from C. Alternatively, it may mean that there is an association relationship between A and B. It should be further understood that the term “corresponding” mentioned in embodiments of this application may mean that there is a direct or indirect correspondence between two elements, or that there is an association between two elements, or that there is a relationship of “indicating” and “being indicated”, “configuring” and “being configured”, or the like. It should be further understood that the “predefined” or “predefined rule” mentioned in embodiments of this application may be implemented in a manner in which corresponding code, a table, or other related information used for indication is pre-stored in a device (for example, including a terminal device and a network device). A specific implementation is not limited in this application. For example, pre-defining may refer to being defined in a protocol. It should be further understood that in embodiments of this application, the “protocol” may refer to a standard protocol in the communication field, for example, may include an LTE protocol, an NR protocol, and a related protocol applied to a future communications system. This is not limited in this application.

To facilitate understanding of the technical solutions in embodiments of this application, the following describes related technologies in embodiments of this application. The following related technologies may be randomly combined with the technical solutions in embodiments of this application as optional solutions, which are all within the protection scope of embodiments of this application.

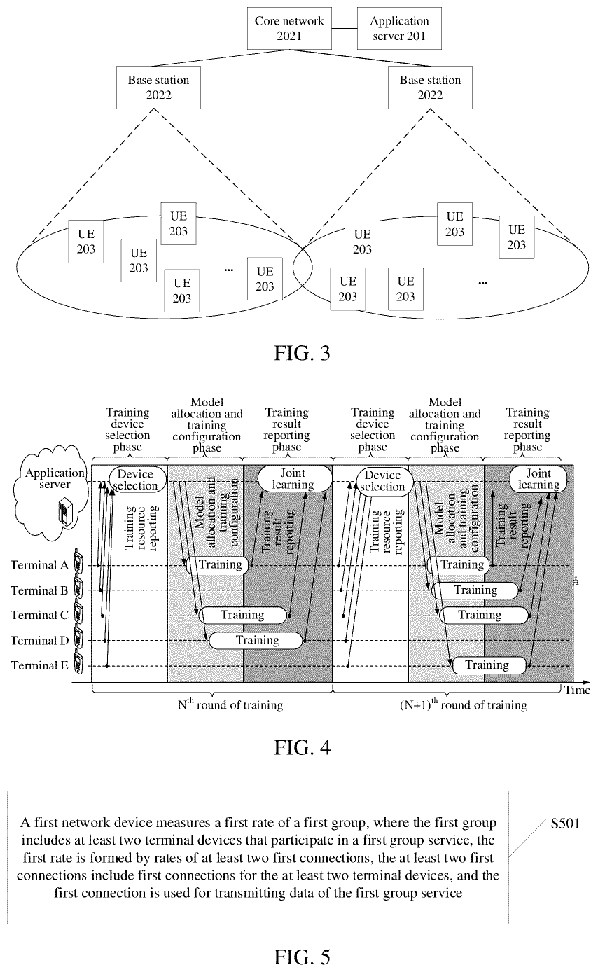

In a group service, as shown in FIG. 2 or FIG. 3, an application server 201 exchanges data with a plurality of terminals 203 by using a 5G system 202 (5GS, including a core network 2021+a base station 2022). In FIG. 2, a plurality of terminals 203 are located in coverage of one base station 2022. In FIG. 3, a plurality of terminals 203 are located in coverage of two base stations 2022. In actual application, the application server 201 may interact with a plurality of terminals 203 by using one or more base stations 2022.

An example in which the group service is federated learning (FL) is used. Due to a scheduling requirement of an application layer, an application server may select different terminal devices in each round (or each time period). For example, there are 100 terminal devices covered by a base station, and each round (or each time period) the application server interacts with 10 terminal devices in the 100 terminal devices as required, so that the 10 terminal devices may return a training result (a trained model/result) of local data to the application server, and the application server performs further processing (for example, combining and weighing training results of a plurality of terminal devices). After completing one training round with the 10 terminal devices, the application server may select another 10 terminal devices (part of the 10 terminal devices may be the same as those in the previous round, or all the 10 terminal devices may be different from those in the previous round, which is not limited), to start a new round of training result reporting.

A process of federated learning in each training round (for example, training round N and training round N+1) is shown in FIG. 4. Each training round includes a training device selection phase, a model allocation and training configuration phase, and a training result reporting phase.

In the training device selection phase, each terminal device reports a training resource, and an application server reports, based on the training resources reported by all the terminal devices, selects a training terminal device from all terminal devices.

In the model allocation and training configuration phase, the application server sends a model allocation and training configuration to a selected terminal device, and a terminal device that received the model allocation and training configuration performs training.

In the training result reporting phase, a terminal device that completes training reports a training result to the application server, and the application server completes joint learning based on the reported training result.

As shown in FIG. 4, terminal devices that participate in federated learning include a terminal A, a terminal B, a terminal C, a terminal D, and a terminal E. In the N^{th} round of training, each of the terminal A, the terminal B, the terminal C, the terminal D, and the terminal E reports a training resource to the application server. The application server selects, according to the training resources reported by these terminal devices, the terminal A, the terminal C, and the terminal D to participate in the N^{th} round of training; and after completing training, each of the terminal A, the terminal C, and the terminal D reports a training result to the application server, and the application server performs the N^{th} round of joint learning. In the (N+1) th round of training, each of the terminal A, the terminal B, the terminal C, the terminal D, and the terminal E reports a training resource to the application server. The application server selects, according to the training resources reported by these terminal devices, the terminal A, the terminal B, the terminal C, and the terminal E to participate in the (N+1) th round of training; and after completing training, each of the terminal A, the terminal B, the terminal C, and the terminal E reports a training result to the application server, and the application server performs the (N+1) th round of joint training.

Federated learning has many advantages, including:
user data being stored locally without being exposed, effectively protecting user privacy;
computing power being shared to a plurality of nodes to speed up a training process; and
multi-node data sets being combined to solve a data silo problem.

Implementation of federated learning requires the application server to mobilize a plurality of terminal devices, which consumes communication resources. If the application server for federated learning is allowed to invoke wireless resources of a plurality of terminal devices without restriction, another terminal device or another service will be inevitably affected. Therefore, there is a need for an effective management and control method that can meet a requirement of federated learning for limiting bandwidth (rate) on demand and that can support dynamic scheduling reported by a plurality of terminal devices. An existing communications network does not have the following functions:
1. control of group wireless resources (for example, an aggregate bit rate of a group) in a case that a plurality of terminal devices and an application server jointly perform a specific service (for example, federated learning);
2. an effective way to limit a group rate in a case that a plurality of terminal devices and an application server jointly perform a specific service (for example, federated learning).

To facilitate understanding of the technical solutions in embodiments of this application, the following describes the technical solutions in this application in detail by using specific embodiments. The foregoing related technologies, as optional solutions, may be randomly combined with the technical solutions of embodiments of this application, all of which fall within the protection scope of embodiments of this application. Embodiments of this application include at least a part of the following content.

A wireless communication method provided in an embodiment of this application is applied to a first network device. As shown in FIG. 5, the method includes:
in S501, measuring, by a first network device, a first rate of a first group, where the first group includes at least two terminal devices that participate in a first group service, the first rate is formed by rates of at least two first connections, the at least two first connections include first connections for the at least two terminal device, and the first connection is used for transmitting data of the first group service.

In this embodiment of this application, the first group is a group formed by the terminal devices that participate in the first group service, and the first group service may be but is not limited to federated learning.

For any one of the terminal devices in the first group, there may be a plurality of connections. A connection for transmitting data of the first group service is the first connection, and some or all connections are the first connections. In an example, for a terminal device A in the first group, there are a connection A1, a connection A2, a connection A3, and a connection A4; and the connection A1 and the connection A2 are used for transmitting data of the first group service, and thus the connection A1 and the connection A2 belong to the first connections.

In this embodiment of this application, a sum of rates of the first connections for the terminal devices included in the first group is the first rate.

In an example, the first group includes a terminal device A, a terminal device B, and a terminal device C, and the first connection of the terminal device A includes a connection A1 and a connection A2; the first connection of the terminal device B includes a connection B2; and the first connection of the terminal device C includes a connection C3. In this case, the first rate of the first group is a sum of rates of the connection A1, the connection A2, the connection B2, and the connection C3.

The first network device measures rates of the first connections for terminal devices in the first group, and adds measurement results of the first connections to obtain a measurement value of the first rate, namely, a real-time first rate. Optionally, the first network device may measure rates of first connections for all terminal devices in the first group at a specific time, and add measured rates of all the first connections to obtain a measurement value of the first rate of the first group. Optionally, the first network device may perform averaging on aggregate bit rates measured over a period of time (for example, a time window of 100 ms) to obtain a measurement value of the first rate of the first group. Optionally, the first network device may measure rates of first connections for all terminal devices in the first group over a period of time (for example, a time window of 100 ms) to obtain average rates of the first connections over the period of time, and add all the average rates of the first connections in the period of time to obtain a measurement value of the first rate of the first group.

Herein, the first rate of the first group may be understood as an aggregate bit rate of the first group, and the measurement value of the first rate of the first group may be understood as a real-time aggregate bit rate of the first group.

In this embodiment of this application, the first connections are used for transmitting data of the first group service. During measurement of the first rate, the first connections may be used for transmitting data of the first group service, or may not be used for transmitting data of the first group service.

In an example, the first group includes a terminal device A, a terminal device B, and a terminal device C, and the first connection of the terminal device A includes a connection A1 and a connection A2; the first connection of the terminal device B includes a connection B2; and the first connection of the terminal device C includes a connection C3. At a time t1, the connection A1 and the connection A2 of the terminal device A are not used for transmitting data. When the first network device measures the first rate at the time t1, a sum of rates of the connection A1, the connection A2, the connection B2, and the connection C3 is measured.

In still another example, federated learning is the first group service. Terminal devices that participate in federated learning include 100 terminal devices, that is, the first group includes 100 terminal devices, terminal devices that participate in training in each round include 10 terminal devices of the 100 terminal devices, and each of the 10 terminal devices reports a training result to the application server. When measuring the first rate, the first network device measures rates of the first connections for the 100 terminal devices included in the first group, to obtain a measurement value of the first rate.

In this embodiment of this application, the measurement value of the first rate may be used to control the first rate. After obtaining the measurement value of the first rate, the first network device may control the first rate based on the measurement value of the first rate. Optionally, if the measurement value of the first rate meets an adjustment condition, the first network device adjusts the first rate. Optionally, if the measurement value of the first rate does not meet the adjustment condition, the first network device does not adjust the first rate.

In this embodiment of this application, a target for adjusting the first rate may include: reducing the first rate, that is, the measurement value of the first rate is used for determining whether to reduce the first rate, so as to limit the first rate.

After adjusting the first rate, the first network device may continue to measure an adjusted first rate. When a measurement value, obtained through another measurement, of the first rate meets the adjustment condition, the first network device continues to adjust the first rate. The adjustment to the first rate is not stopped until at least one of the following conditions is met: a measurement value of the first rate does not meet the adjustment condition, or an adjustment quantity reaches an adjustment quantity threshold.

In this embodiment of this application, after the first rate of the first group is adjusted, if a first rate obtained after adjustment does not meet the adjustment condition, it may be considered that the first rate meets a condition for stopping adjustment. In this case, the first network device stops adjusting the first rate.

In this embodiment of this application, the condition for the first network device to stop adjusting the first rate is not limited.

In this embodiment of this application, the first network device may be a first base station or a UPF.

In a case that at least two terminal devices in the first group are distributed under coverage of a plurality of base stations, the first base station is any base station in the plurality of base stations.

In a case that the first network device is the first base station, and at least two terminal devices in the first group are distributed under coverage of a plurality of base stations, the first base station measures rates of one or more first connections served by the first base station, and acquires, through an interface between the first network device and another base station, measurement values of rates of the first connections served by another base station, to obtain the measurement value of the first rate.

In an example, the first group includes a terminal device A, a terminal device B, and a terminal device C, where the terminal device A is distributed under a base station A, and the terminal device B and the terminal device C are distributed under a base station B. The first connection of the terminal device A includes a connection A1 and a connection A2, the first connection of the terminal device B includes a connection B2, and the first connection of the terminal device C includes a connection C3. The base station A measures rates of the connection A1 and the connection A2, to obtain measurement values of the rates of the connection A1 and the connection A2. The base station B measures rates of the connection B2 and the connection C3, to obtain measurement values of the rates of the connection B2 and the connection C3. The base station A receives, by interacting with the base station B, the measurement values of the rates of the connection B2 and the connection C3, and then obtains the first rate of the first group based on the measurement values, obtained through measurement, of the rates of the connection A1 and the connection A2 and the received measurement values of the rates of the connection B2 and the connection C3.

In a case that the first network device is a UPF, the UPF serves at least two terminal devices in the first group. In this case, the UPF can measure and control the first connections for the at least two terminal devices in the first group.

In some embodiments, the first connection may be a PDU session or a quality of service (QoS) flow.

If the first connection is a PDU session, the first network device measures and controls the first rate of the first group at a granularity that is the PDU session.

If the first connection is a QoS flow, the first network device measures and controls the first rate of the first group at a granularity of a QoS flow.

According to the wireless communication method provided in embodiments of this application, rates of connections for a group service performed by terminal devices in a same group are measured, so as to manage and control rates of a plurality of terminal devices that participate in the group service.

In some embodiments, the first connection is configured with a guaranteed bit rate (GBR); or the first connection is not configured with a GBR.

In embodiments of this application, when the first connection is a QoS flow, the GBR configured for the first connection may be understood as a guaranteed flow bit rate (GFBR).

In embodiments of this application, in a plurality of first connections corresponding to the first group, all of the first connections may be configured with a GBR, or none of the first connections is configured with a GBR, or some of the first connections may be configured with a GBR and the others may not be configured with a GBR.

In embodiments of this application, the terminal devices in the first group establish a connection to a core network through the first connections, and perform transmission of data of the first group service by using first connections configured with a GBR, or may perform transmission of data of the first group service by using first connections not configured with a GBR.

In some embodiments, a sum of GBRs of the at least two first connections is greater than an aggregate maximum bit rate (AMBR) of the first group.

Herein, in the plurality of first connections corresponding to the first group, some or all of the plurality of first connections corresponding to the first group may be configured with a GBR. A sum of GBRs of the first connections configured with a GBR is greater than the AMBR of the first group.

In an example, a value of the AMBR of the first group is 20 Mbps, and a sum of GBRs of first connections for 10 terminal devices included in the first group may be greater than 20 Mbps, for example, may be 40 Mbps, 50 Mbps, or the like. The first connections for the 10 terminal devices included in the first group may be all configured with a GBR, or may be some configured with a GBR.

In actual application, all the terminal devices in the first group may participate in one group service, or may participate in a plurality of group services. In a case that all terminal devices in the first group participate in one group service, namely, the first group service, the first group corresponds to one ABMR. In a case that all terminal devices in the first group participate in a plurality of group services, the first group corresponds to a plurality of AMBRs, and the AMBRs respectively correspond to the group services, that is, one group service corresponds to one AMBR.

In a case that the plurality of terminal devices included in the first group may simultaneously participate in a plurality of group services, one group service corresponds to one AMBR. In this case, a sum of GBRs of first connections for transmitting the first group service is greater than the AMBR corresponding to the first group service, where the first group service is any group service in the plurality of group services in which the plurality of terminal devices participated.

In an example, the first group includes 10 terminal devices, and the 10 terminal devices simultaneously participate in three group services: a group service 1, a group service 2, and a group service 3. In this case, the first group corresponds to an AMBR 1, an AMBR 2, and an AMBR 3, and the AMBR 1, AMBR 2, and AMBR 3 are AMBRs corresponding to the group service 1, the group service 2, and the group service 3, respectively. In this case, a sum of GBRs of first connections for transmitting the group service 1 by the 10 terminals is greater than the AMBR 1; a sum of GBRs of first connections for transmitting the group service 2 by the 10 terminals is greater than the AMBR 2; and a sum of GBRs of first connections for transmitting the group service 3 by the 10 terminals is greater than the AMBR 3.

In embodiments of this application, a sum of GBRs of a plurality of first connections corresponding to the first group is greater than the AMBR of the first group, so that the first network device has enough space to adjust the first rate.

In some embodiments, an adjustment condition of the first rate includes: a measurement value of the first rate is greater than a first rate threshold.

In this case, when the measurement value of the first rate is greater than the first rate threshold, it is determined that the first rate meets the adjustment condition, and the first network device reduces the first rate.

In some embodiments, a condition for stopping adjustment of the first rate includes: a measurement value of the first rate is less than or equal to a first rate threshold.

Herein, the first rate threshold is used for determining, together with the measurement value of the first rate, whether to adjust the first rate. In a case that a plurality of terminal devices in the first group participate in a plurality of group services, one group service corresponds to one rate threshold, and the first rate threshold used for determining whether to adjust the first rate is a rate threshold corresponding to the first group service.

When the measurement value of the first rate measured by the first network device is greater than the first rate threshold, adjustment is performed on the first rate, and after the first rate is adjusted, an adjusted first rate continues to be measured. When a measurement value of the first rate measured again is less than or equal to the first rate threshold, measurement of the first rate is stopped. When the measurement value of the first rate measured again is still greater than the first rate threshold, the first rate continues to be adjusted until a measurement value of an adjusted first rate is less than or equal to the first rate threshold.

That the first rate threshold is 50 Mbps is used as an example. When the measurement value, measured by the first network device for the first time, of the first rate is 68 Mbps, the first rate is adjusted for the first time. The first network device performs a second measurement on a first rate to obtain a measurement value of the first rate after the first adjustment as 65 Mbps. In this case, the first network device adjusts the first rate for a second time. The first network device performs a third measurement on a first rate to obtain a measurement value of the first rate after the second adjustment as 53 Mbps. In this case, the first network device adjusts the first rate for the third time. The first network device performs a fourth measurement on a first rate to obtain a measurement value of the first rate after the third adjustment as 49 Mbps, and then adjustment on the first rate is stopped.

In some embodiments, an adjustment manner of the first rate includes at least one of the following:
Adjustment manner 1: limiting a rate of at least one of the first connections;
Adjustment manner 2: limiting a rate of a data radio bearer (DRB) corresponding to at least one of the first connections;
Adjustment manner 3: deactivating at least one of the first connections;
Adjustment manner 4: deactivating a DRB corresponding to at least one of the first connections;
Adjustment manner 5: deleting at least one of the first connections; or
Adjustment manner 6: deleting a DRB corresponding to at least one of the first connections.

In Adjustment manner 1, the first network device limits rates of one or more first connections. A rate of a first connection may be limited by adjusting a QoS parameter of the first connection or reducing a rate of the first connection.

The first network device may limit the rate of the first connection at a granularity that is a first connection or a terminal device.

In a case that a first connection is used as a granularity, rates of one or more first connections in the plurality of first connections corresponding to the first group are limited.

In an example, the first group includes a terminal device A, a terminal device B, and a terminal device C. At least two first connections corresponding to the first group include a connection A1, a connection A2, a connection B2, and a connection C3, where the connection A1 and the connection A2 are the first connection for the terminal device A, the connection B2 is the first connection for the terminal device B, and the connection C3 is a first connection for the terminal device C. When adjusting the first rate, the first network device may reduce the first rate by limiting the connection A1.

In a case that a terminal device is used as a granularity, rates of first connections for one or more terminal devices in the first group are limited.

In an example, the first group includes a terminal device A, a terminal device B, and a terminal device C. At least two first connections corresponding to the first group include a connection A1, a connection A2, a connection B2, and a connection C3, where the connection A1 and the connection A2 are the first connection for the terminal device A, the connection B2 is the first connection for the terminal device B, and the connection C3 is the first connection for the terminal device C. When adjusting the first rate, the first network device may reduce the first rate by limiting a rate of the first connection, namely, the connection A1 and the connection A2, for the terminal device A.

In Adjustment manner 2, the first network device may reduce rates of DRBs corresponding to one or more first connections.

The first network device may limit a rate of a DRB corresponding to a first connection at a granularity of a first connection or a terminal device.

In a case that a first connection is used as a granularity, rates of DRBs corresponding to one or more first connections in the plurality of first connections corresponding to the first group are limited.

In a case that a terminal device is used as a granularity, rates of DRBs corresponding to first connections for one or more terminal devices in the first group are limited.

In Adjustment manner 3, the first network device temporarily deactivates one or more first connections from data transmission, but the first connections still present. After a period of time, the first connections may be activated to resume data transmission.

The first network device may deactivate a first connection at a granularity of a first connection or a terminal device.

In a case that a first connection is used as a granularity, one or more first connections in the plurality of first connections corresponding to the first group are deactivated.

In a case that a terminal device is used as a granularity, first connections for one or more terminal devices in the first group are deactivated.

Herein, a deactivated first connection may be activated after first duration, and activation of the deactivated first connection may be controlled based on a timer, or may be controlled by a core network device.

In Adjustment manner 4, the first network device temporarily deactivates DRBs corresponding to one or more first connections from data transmission, but the first connections still present. After a period of time, the DRBs of the first connections may be activated to resume data transmission.

The first network device may deactivate a DRB corresponding to a first connection at a granularity of a first connection or a terminal device.

A deactivated DRB corresponding to a first connection may be activated after second duration, and activation of the deactivated DRB corresponding to the first connection may be controlled based on a timer, or may be controlled by a core network device.

In a case that a first connection is used as a granularity, DRBs corresponding to one or more first connections in the plurality of first connections corresponding to the first group are deactivated.

In a case that a terminal device is used as a granularity, DRBs corresponding to first connections for one or more terminal devices in the first group are deactivated.

In Adjustment manner 5, the first network device deletes one or more first connections, and the deleted first connections are absent.

The first network device may delete a first connection by using a first connection or a terminal device as a granularity.

In a case that a first connection is used as a granularity, one or more first connections in the plurality of first connections corresponding to the first group are deleted.

In a case that a terminal device is used as a granularity, first connections for one or more terminal devices in the first group are deleted.

In Adjustment manner 6, the first network device deletes DRBs of one or more first connections, and the deleted DRBs are absent.

The first network device may delete a DRB corresponding to a first connection at a granularity of a first connection or a terminal device.

In a case that a first connection is used as a granularity, DRBs corresponding to one or more first connections in the plurality of first connections corresponding to the first group are deleted.

In a case that a terminal device is used as a granularity, DRBs corresponding to first connections for one or more terminal devices in the first group are deleted.

Optionally, Adjustment manner 1, Adjustment manner 3, and Adjustment manner 5 may be applied to a UPF for adjusting the first rate.

Optionally, Adjustment manner 2, Adjustment manner 4, and Adjustment manner 6 may be applied to a first base station for adjusting the first rate.

In a case that the first network device is an UPF, the UPF may decrease the first rate locally, or may directly instruct a second base station to decrease the first rate, or may instruct, by means of a second network device, a second base station to reduce the first rate.

That the first network device is a UPF is used as an example, and the UPF limits a rate of at least one first connection.

In this case, the UPF locally limits the rate of the at least one first connection to reduce the first rate, and an adjustment manner used by the UPF to adjust the first rate is Adjustment manner 1.

That the first network device is a UPF is used as an example. The UPF transmits, to the second base station, first indication information for indicating at least one of the following:
limiting a rate of at least one of the first connections served by the second base station;
deactivating at least one of the first connections served by the second base station; or
deleting at least one of the first connections served by the second base station.

In this case, the UPF directly instructs the second base station to reduce the first rate. An adjustment manner used by the UPF to adjust the first rate may include one or more of Adjustment manner 1, Adjustment manner 3, and Adjustment manner 5.

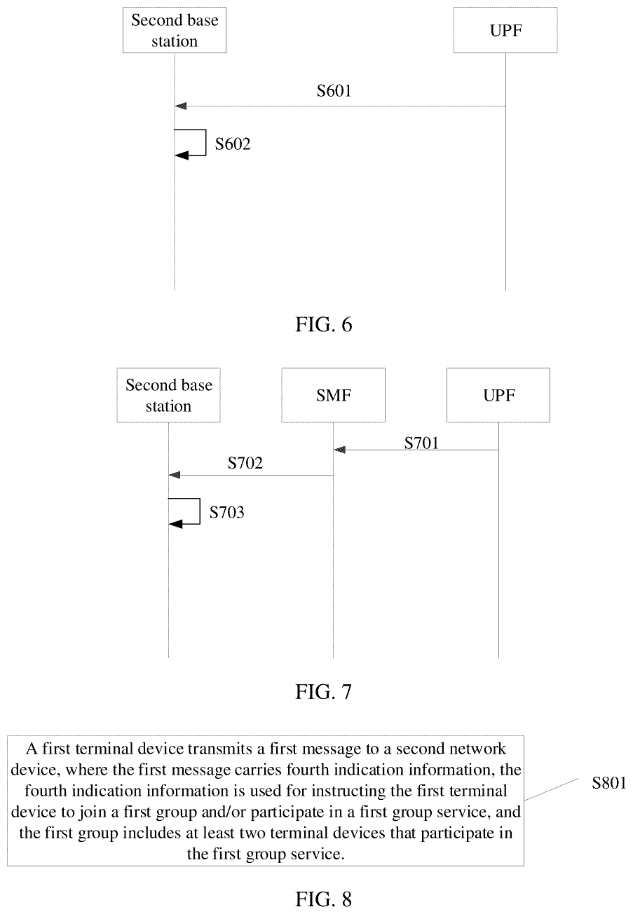

As shown in FIG. 6, a wireless communication method provided in an embodiment of this application may include the following steps.

In S601, a UPF transmits first indication information to a second base station.

In S602, the second base station reduces the first rate based on the received first indication information.

Herein, the first indication information indicates a first connection that needs to be adjusted, and indicates an adjustment type for adjusting the first connection, where the adjustment type includes one or more of rate limiting, deactivation, and deletion. Herein, in a case that there are a plurality of first connections that need to be adjusted, adjustment types of different first connections may be identical or different.

After determining to adjust the first rate, the UPF determines the first connection that needs to be adjusted, determines the adjustment type, generates the first indication information based on an identifier for identifying the first connection that needs to be adjusted and a type identifier indicating the adjustment type, and transmits the first indication information to the second base station. The second base station performs, based on the received first indication information, rate limiting or deactivation or deletion on the first connection. In actual application, in a case that first connections that need to be adjusted are distributed on a plurality of second base stations, the UPF may transmit the first indication information to each of the second base stations. After receiving the first indication information, each of the second base stations adjusts a first connection, served by itself, among the first connections indicated in the first indication information; or the UPF may determine second base stations that are respectively corresponding to the first connections that need to be adjusted, and the first indication information transmitted to each of the second base stations indicates only a first connection served by the corresponding second base station.

In an example, the first connections that need to be adjusted include a connection 1, a connection 2, and a connection 3, and a base station 1 serves the connection 1, and a base station 2 serves the connection 2 and the connection 3. The UPF transmits, to the base station 1 and the base station 2, first indication information indicating rate limiting for the connection 1, the connection 2, and the connection 3. After receiving the first indication information, the base station 1 limits a rate of the connection 1. After receiving the first indication information, the base station 2 limits rates of the connection 2 and the connection 3.

In an example, the first connections that need to be adjusted include a connection 1, a connection 2, and a connection 3, and a base station 1 serves the connection 1, and a base station 2 serves the connection 2 and the connection 3. The UPF transmits, to the base station 1, first indication information A indicating rate limiting for the connection 1, and transmits, to the base station 2, first indication information B indicating rate limiting for the connection 2 and the connection 3. After receiving the first indication information A, the base station 1 limits a rate of the connection 1. After receiving the first indication information B, the base station 2 limits rates of the connection 2 and the connection 3.

That the first network device is a UPF is used as an example. The UPF sends first information to a second network device, and the first information is used for indicating a measurement value of the first rate.

In this case, the UPF instructs, by mean of the second network device, a second base station to reduce the first rate, and an adjustment manner used by the UPF to adjust the first rate may include one or more of Adjustment manner 1, Adjustment manner 3, and Adjustment manner 5.

When determining that the measurement value of the first rate is greater than a first rate threshold, the UPF transits the first information to the second network device, to notify the second network device of reducing the first rate. Optionally, the second network device is a control plane network element, for example, an SMF, of a core network.

When receiving the first information, the second network device may determine that the first rate needs to be reduced, and instruct the second base station to reduce the first rate.

In some embodiments, the first information includes at least one of the following:
the measurement value of the first rate; or
second indication information for indicating that the measurement value of the first rate is greater than a first rate threshold.

In a case that the first information is the measurement value of the first rate, the second network device may directly instruct the second base station to reduce the first rate, or may compare a received measurement value of the first rate with the first rate threshold, and when determining that the measurement value of the first rate is greater than the first rate threshold, instruct the second base station to reduce the first rate.

In some embodiments, the first information is used for determining third indication information transmitted by the second network device to the second base station, and the third indication information is used for indicating at least one of the following:
limiting a rate of at least one of the first connections served by the second base station;
deactivating at least one of the first connections served by the second base station; or
deleting at least one of the first connections served by the second base station.

After receiving the first information, the second network device determines the third indication information based on the first information, and transmits the third indication information to the second base station. The second base station reduces the first rate based on the received third indication information.

As shown in FIG. 7, a wireless communication method provided in an embodiment of this application may include the following steps.

In S701, a UPF transmits first information to an SMF.

In S702, the SMF transmits third indication information to a second base station.

In S703, the second base station reduces a first rate based on the received third indication information.

The third indication information indicates a first connection that needs to be adjusted, and indicates an adjustment type for adjusting the first connection, where the adjustment type includes one or more of rate limiting, deactivation, and deletion. Herein, in a case that there are a plurality of first connections that need to be adjusted, adjustment types of different first connections may be identical or different.

After determining to adjust the first rate, a second network device determines the first connection that needs to be adjusted, determines the adjustment type, generates the first indication information based on an identifier for identifying the first connection that needs to be adjusted and a type identifier indicating the adjustment type, and transmits the first indication information to the second base station. The second base station performs, based on the received first indication information, rate limiting or deactivation or deletion on the first connection.

In actual application, in a case that first connections that need to be adjusted are distributed on a plurality of second base stations, the second network device may transmit the first indication information to each of the second base stations. After receiving the first indication information, each of the second base stations adjusts a first connection, served by itself, among the first connections indicated in the first indication information; or the second network device may determine second base stations that are respectively corresponding to the first connections that need to be adjusted, and the first indication information transmitted to each of the second base stations indicates only a first connection served by the corresponding second base station.

In a case that the adjustment type indicated by the first indication information received by the second base station is deactivation, the second base station may activate a deactivated first connection after a period of time.

In an example, in a case that the second station deactivates at least one first connection, the second base station may start a timer, and when the timer has completed its countdown, the second base station activates the deactivated first connection.

In an example, the second network device transmits an activation indication to the second base station, and when receiving the activation indication, the second base station activates the deactivated first connection.

In a case that a first network device is a first base station, the first base station performs one or more of adjustments including rate limiting, deactivation, and deletion on a DRB of at least one connection served by the first base station.

In a case that terminal devices in a first group are distributed on a plurality of base stations, the first base station may adjust only a first connection served by the first base station. In first connections corresponding to the first group, another first connection other than the first connection served by the first base station may be adjusted by the UPF, or may be adjusted by a first base station serving the another first connection.

In some embodiments, a first rate threshold is an AMBR of the first group.

In a case that the terminal devices included in the first group participate in a group service, the first rate threshold is an AMBR of the first group.

In a case that the terminal devices included in the first group participate in a plurality of group services, one group service corresponds to one AMBR, and the first rate threshold is an AMBR corresponding to a first group service in the plurality of AMBRs corresponding to the first group.

In some embodiments, the first connection corresponds to an independent DRB.

In embodiments of this application, DRBs are separately created for different first connections, so that no interference occurs between the different first connections when the first base station reduces the first rate by performing rate limiting, deactivation, or deletion on the DRB.

According to the wireless communication method provided in embodiments of this application, rates of connections for a group service performed by terminal devices in a same group are measured, so as to manage and control rates of a plurality of terminal devices that participate in a same group service; and rates of the connections of the group service are adjusted, to implement dynamic scheduling of the rates of a plurality of terminal devices participating in the group service.

An embodiment of this application provides a wireless communication method, applied to a first terminal device. As shown in FIG. 8, the method includes:
in S801, transmitting, by the first terminal device, a first message to a second network device, where the first message carries fourth indication information, the fourth indication information is used for instructing the first terminal device to join a first group and/or participate in a first group service, and the first group includes at least two terminal devices that participate in the first group service.

When determining to join the first group and/or participate in the first group service, the first terminal device transmits the first message to the second network device, where the first message carries fourth indication information for instructing the second network device to join the first group or participate in the first group service. The second network device is a control plane network element, for example, an SMF, of a core network.

Optionally, the fourth indication information is used for instructing the first terminal device to participate in the first group service, and the second network device determines, based on the fourth indication information, that the first terminal device joins the first group corresponding to the first group service.

Optionally, the fourth indication information is used for instructing the first terminal device to join the first group, and the second network device determines, based on the fourth indication information, that the first terminal device joins the first group.

Optionally, the fourth indication information is used for instructing the first terminal device to join the first group and participate in the first group service, and the second network device determines, based on the fourth indication information, that the first terminal device joins the first group.

In some embodiments, the first message is used for establishing or updating a PDU session.

In a case that the first message is used for establishing or updating a PDU session, the first message may be a PDU session establishment/modification request transmitted by the first terminal device to the second network device. In this case, the first terminal device adds the fourth indication information to the PDU session establishment/modification request, and transmits, to the second network device, the PDU session establishment/modification request with the fourth indication information added.

Herein, when the first message is used for establishing or updating a PDU session, the first terminal device notifies the core network of joining of the first group during PDU session establishment or modification.

In some embodiments, the fourth indication information is at least used for the second network device to determine a third network device.

After receiving the fourth indication information, the second network device selects the third network device based on the fourth indication information. Optionally, the third network device is a user plane function, for example, a UPF of the core network.

In some embodiments, the third network device serves at least two terminal devices in the first group.

Herein, the second network device determines, based on the fourth indication information, the first group that the first terminal device joins, and selects a third network device that can serve all terminal devices in the first group.

In some embodiments, the fourth indication information is at least used for determining second information, the second information is at least used for control of a first rate, the first rate is formed by rates of at least two first connections, the at least two first connections include first connections for the at least two terminal devices, and the first connection is used for transmitting data of the first group service.

After the second network device determines the second information based on the fourth indication information, the second information may be carried in a second message and transmitted to the third network device. The third network device establishes the first connection of the first terminal device based on the received second information.

Herein, the second network device may notify the third network device of the following content through the second information: the first group that the first terminal device joins, a first connection that needs to be established by the first terminal device, namely, a connection, participating in control of the first rate, of the first terminal device, and an AMBR updated based on joining of the first terminal device.

Herein, in a case that the fourth indication information indicates the first group service, and terminal devices in the first group participate in a plurality of group services, one group service corresponds to one AMBR. In this case, an AMBR in the second information is an ABMR, corresponding to the first group service, in a plurality of AMBRs corresponding to the first group. In some embodiments, the second information includes at least one of the following:
a QoS parameter of the first terminal device;
a QoS rule of the first terminal device;
fifth indication information for indicating a first connection of the first terminal device; or
sixth indication information for indicating an AMBR of the first group.

The QoS parameter may include parameters such as a QoS class identifier (QCI), and an allocation/retention priority (ARP).

The QoS rule includes an identifier of an associated QoS flow, a priority of the QoS rule, or the like.

The fifth indication information is used for indicating a first connection that is of the first terminal device and that is used for transmitting data of the first group service. Herein, after the second network device transmits the fifth indication information to the third network device, the third network device establishes the first connection for the first terminal device based on the fifth indication information. The first terminal device corresponds to one or more first connections.

An AMBR, indicated by the sixth indication information, of the first group is an AMBR obtained after the first terminal device joins the first group.

Herein, the AMBR indicated by the sixth indication information may be used as the first rate threshold in the wireless communication method illustrated in FIG. 5, which is used for the UPF or the first base station to control the first rate of the first group.

In some embodiments, the sixth indication information includes at least one of the following:
the AMBR;
a first identifier for indicating the AMBR; or
a second identifier of the first group service.

The sixth indication information is used for determining a value of the AMBR of the first group.

In a case that the sixth indication information includes the AMBR, the sixth indication information directly indicates the AMBR.

In a case that the sixth indication information includes the first identifier, after receiving the first identifier, the third network device searches for, based on the first identifier, an AMBR identified by the first identifier.

In a case that the sixth indication information includes the second identifier, the third network device receives the second identifier, and determines, based on the second identifier, the AMBR corresponding to the first group service.

In some embodiments, the first connection is a PDU session or a quality of service QoS flow.

In some embodiments, the first connection corresponds to an independent DRB.

In embodiments of this application, for first connections, a base station may establish a DRB for each of the first connections. Thus, in a process of implementing the wireless communication method illustrated in FIG. 5, it is convenient for control of the first rate based on the DRB, so that different first connections do not affect each other.

In embodiments of this application, in a case that the first terminal device corresponds to a plurality of first connections, QoS parameters of different first connections may be identical or different. For first connections with a same QoS parameter, DRBs may be separately established.

In embodiments of this application, each terminal device to be joined in the first group may join the first group according to the wireless communication method illustrated in FIG. 7, and after the core network completes establishment of the first connection and configuration of the AMBR, the first network device measures the first rate of the first group, and adjusts the first rate based on a measurement result of the first rate and the AMBR of the first group.

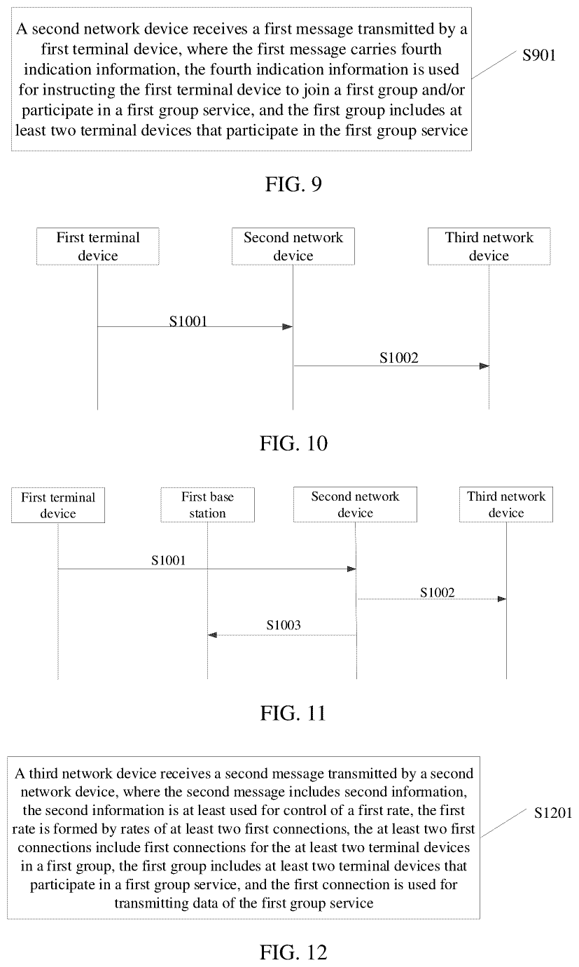

An embodiment of this application provides a wireless communication method, applied to a second network device. As shown in FIG. 9, the method includes the following step:

In S901, receiving, by a second network device, a first message transmitted by a first terminal device, where the first message carries fourth indication information, the fourth indication information is used for instructing the first terminal device to join a first group and/or participate in a first group service, and the first group includes at least two terminal devices that participate in the first group service.

The second network device is a control plane network element, for example, an SMF, of a core network.

When determining to join the first group and/or participate in the first group service, the first terminal device transmits the first message to the second network device, where the first message carries fourth indication information for instructing the second network device to join the first group or participate in the first group service.

Optionally, the fourth indication information is used for instructing the first terminal device to participate in the first group service, and the second network device determines, based on the fourth indication information, that the first terminal device joins the first group corresponding to the first group service.

Optionally, the fourth indication information is used for instructing the first terminal device to join the first group, and the second network device determines, based on the fourth indication information, that the first terminal device joins the first group.

Optionally, the fourth indication information is used for instructing the first terminal device to join the first group and participate in the first group service, and the second network device determines, based on the fourth indication information, that the first terminal device joins the first group.

In some embodiments, the first message is used for establishing or updating a PDU session.

In a case that the first message is used for establishing or updating a PDU session, the first message may be a PDU session establishment/modification request transmitted by the first terminal device to the second network device. In this case, the first terminal device adds the fourth indication information to the PDU session establishment/modification request, and transmits, to the second network device, the PDU session establishment/modification request with the fourth indication information added.

Herein, when the first message is used for establishing or updating a PDU session, the first terminal device notifies the core network of joining of the first group during PDU session establishment or modification.

In some embodiments, the fourth indication information is used for the second network device to determine a third network device.

After receiving the fourth indication information, the second network device selects the third network device based on the fourth indication information. Optionally, the third network device is a user plane function, for example, a UPF of the core network.

In some embodiments, the third network device serves at least two terminal devices in the first group.

Herein, the second network device determines, based on the fourth indication information, the first group that the first terminal device joins, and selects a third network device that can serve all terminal devices in the first group.

In some embodiments, the fourth indication information is further used for determining second information, the second information is at least used for control of a first rate, the first rate is formed by rates of at least two first connections, the at least two first connections include first connections for the at least two terminal devices, and the first connection is used for transmitting data of the first group service.

In some embodiments, the second network device transmits a second message to the third network device, where the second message includes the second information, and the second information is at least used for control of the first rate. The first rate is formed by rates of at least two first connections, the at least two first connections include first connections for the at least two terminal devices, and the first connection is used for transmitting data of the first group service.

After the second network device determines the second information based on the fourth indication information, the second information may be carried in a second message and transmitted to the third network device. The third network device establishes the first connection of the first terminal device based on received second information.

Herein, the second network device may notify the third network device of the following content through the second information: the first group that the first terminal device joins, a first connection that needs to be established by the first terminal device, and an AMBR updated based on joining of the first terminal device.

Herein, in a case that the fourth indication information indicates the first group service, and terminal devices in the first group participate in a plurality of group services, one group service corresponds to one AMBR. In this case, an AMBR in the second information is an ABMR, corresponding to the first group service, in a plurality of AMBRs corresponding to the first group.

In an example, as shown in FIG. 10, a wireless communication method provided in an embodiment of this application includes the following steps.

In S1001, a first terminal device transmits a first message to a second network device.

In S1002, the second network device transmits a second message to a third network device.

In some embodiments, the second message is used for establishing or updating a PDU session.

In some embodiments, the second information includes at least one of the following:
a quality of service QoS parameter of the first terminal device; or
   a QoS rule of the first terminal device;
   fifth indication information for indicating a first connection of the first terminal device; or
   sixth indication information for indicating an AMBR of the first group.

The QoS parameter may include a parameter such as QCI or ARP.

The QoS rule includes an identifier of an associated QoS flow, a priority of the QoS rule, or the like.

The fifth indication information is used for indicating a first connection that is of the first terminal device and that is used for transmitting data of the first group service. Herein, after the second network device transmits the fifth indication information to the third network device, the third network device establishes the first connection for the first terminal device based on the fifth indication information. The first terminal device corresponds to one or more first connections.

In a case that the third network device is a UPF, and the UPF measures the first rate, the third network device may measure rates of first connections of each first terminal device in the first group based on the fifth indication information transmitted by each terminal device in the first group, so as to determine a measurement value of the first rate of the first group.

An AMBR, indicated by the sixth indication information, of the first group is an AMBR obtained after the first terminal device joins the first group.

In a case that the third network device is a UPF, and the UPF controls the first rate, the AMBR indicated by the sixth indication information received by the third network device may be used as the first rate threshold in the wireless communication method illustrated in FIG. 5, to control the first rate of the first group.

In some embodiments, the second network device transmits a third message to the first base station, the third message includes third information, and the third information is at least used for QoS control.

In an example, as shown in FIG. 11, a wireless communication method provided in an embodiment of this application includes the following steps.
In S1001, a first terminal device transmits a first message to a second network device.
In S1002, the second network device transmits a second message to a third network device.
In S1003, the third network device transmits a third message to a first base station.

In some embodiments, the third information includes at least one of the following:
a quality of service QoS parameter of the first terminal device; or
a QoS rule of the first terminal device.

In some embodiments, the third information is further used for instructing the first base station to control a first rate, the first rate is formed by rates of at least two first connections, the at least two first connections include first connections for the at least two terminal devices, and the first connection is used for transmitting data of the first group service.

Herein, in a case that the third information is further used for instructing the first base station to control the first rate, after receiving the third information, the first base station may be used as a first network device to implement the wireless communication method illustrated in FIG. 5 based on the third information.

In some embodiments, the third information includes at least one of the following:
fifth indication information for indicating a first connection of the first terminal device;
sixth indication information for indicating an AMBR of the first group; or
seventh indication information for instructing the first base station to control the first rate.

In a case that the first base station measures the first rate, the first base station may measure rates of first connections of each first terminal device in the first group based on the fifth indication information transmitted by each terminal device in the first group, so as to determine a measurement value of the first rate of the first group.

An AMBR, indicated by the sixth indication information, of the first group is an AMBR obtained after the first terminal device joins the first group.

In a case that the first base station controls the first rate, the AMBR indicated by the sixth indication information received by the first base station may be used as the first rate threshold in the wireless communication method illustrated in FIG. 5, to control the first rate of the first group.

In some embodiments, the sixth indication information includes at least one of the following:
the AMBR;
a first identifier for indicating the AMBR; or
a second identifier of the first group service.

The sixth indication information is used for determining a value of the AMBR of the first group.

In a case that the sixth indication information includes the AMBR, the sixth indication information directly indicates the AMBR.

In a case that the sixth indication information includes the first identifier, after receiving the first identifier, the third network device searches for, based on the first identifier, an AMBR identified by the first identifier.

In a case that the sixth indication information includes the second identifier, the third network device receives the second identifier, and determines, based on the second identifier, the AMBR corresponding to the first group service.

In some embodiments, the first connection is a PDU session or a quality of service QoS flow.

In some embodiments, the first connection corresponds to an independent data radio bearer DRB.

In embodiments of this application, for first connections, a base station may establish a DRB for each of the first connections. Thus, in a process of implementing the wireless communication method illustrated in FIG. 5, it is convenient for control of the first rate based on the DRB, so that different first connections do not affect each other.

In embodiments of this application, in a case that the first terminal device corresponds to a plurality of first connections, QoS parameters of different first connections may be identical or different. For first connections with a same QoS parameter, DRBs may be separately established.

In embodiments of this application, each terminal device to be joined in the first group may join the first group according to the wireless communication method illustrated in FIG. 7, and after the core network completes establishment of the first connection and configuration of the AMBR, the first network device measures the first rate of the first group, and adjusts the first rate based on a measurement result of the first rate and the AMBR of the first group.

An embodiment of this application provides a wireless communication method, applied to a third network device. As shown in FIG. 12, the method includes the following step:
in S1201, receiving, by the third network device, a second message transmitted by a second network device, where the second message includes second information, the second information is at least used for control of a first rate, the first rate is formed by rates of at least two first connections, the at least two first connections include first connections for the at least two terminal devices in a first group, the first group includes at least two terminal devices that participate in a first group service, and the first connection is used for transmitting data of the first group service.

Optionally, the third network device is a user plane function, for example, a UPF of the core network.

Optionally, the second network device is a control plane network element, for example, an SMF, of a core network.

Herein, after the second network device determines the second information, the second information is carried in the second message and transmitted to the third network device, and the third network device receives the second message that carries the second information.

When determining to join the first group and/or participate in the first group service, the first terminal device transmits a first message to the second network device, and fourth indication information is carried in the first message, so as to notify the second network device that the first terminal device needs to join the first group. After receiving the first message, the second network device generates the second information based on the fourth indication information, adds the second information to the second message, and transmits the second message to the third network device. The third network device receives the second message that carries the second information and is transmitted by the second network device. The fourth indication information is used for instructing the first terminal device to join a first group and/or participate in a first group service, and the first group includes at least two terminal devices that participate in the first group service.

Herein, the second network device may notify the third network device of the following content through the second information: the first group that the first terminal device joins, a first connection that needs to be established by the first terminal device, and an AMBR updated based on joining of the first terminal device.

In some embodiments, the second information includes at least one of the following:
a QoS parameter of a first terminal device, where the first terminal device is any one of the terminal devices in the first group;
a QoS rule of the first terminal device;
fifth indication information for indicating a first connection of a first terminal device; or
sixth indication information for indicating an AMBR of the first group.

The QoS rule includes an identifier of an associated QoS flow, a priority of the QoS rule, or the like.

The QoS parameter may include a parameter such as QCI or ARP.

The fifth indication information is used for indicating a first connection that is of the first terminal device and that is used for transmitting data of the first group service. Herein, after the second network device transmits the fifth indication information to the third network device, the third network device establishes the first connection for the first terminal device based on the fifth indication information. The first terminal device is corresponding to one or more first connections.

An AMBR, indicated by the sixth indication information, of the first group is an AMBR obtained after the first terminal device joins the first group.

Herein, the AMBR indicated by the sixth indication information may be used as the first rate threshold in the wireless communication method illustrated in FIG. 5, which is used for the UPF or the first base station to control the first rate of the first group.

In some embodiments, the sixth indication information includes at least one of the following:
the AMBR;
a first identifier for indicating the AMBR; or
a second identifier of the first group service.

The sixth indication information is used for determining a value of the AMBR of the first group.

In a case that the sixth indication information includes the AMBR, the sixth indication information directly indicates the AMBR.

In a case that the sixth indication information includes the first identifier, after receiving the first identifier, the third network device searches for, based on the first identifier, an AMBR identified by the first identifier.

In a case that the sixth indication information includes the second identifier, the third network device receives the second identifier, and determines, based on the second identifier, the AMBR corresponding to the first group service.

In some embodiments, the second message is used for establishing or updating a PDU session.

In some embodiments, the first connection is a PDU session or a quality of service QoS flow.

In some embodiments, the first connection corresponds to an independent DRB.

In embodiments of this application, for first connections, a base station may establish a DRB for each of the first connections. Thus, in a process of implementing the wireless communication method illustrated in FIG. 5, it is convenient for control of the first rate based on the DRB, so that different first connections do not affect each other.

In embodiments of this application, in a case that the first terminal device corresponds to a plurality of first connections, QoS parameters of different first connections may be identical or different. For first connections with a same QoS parameter, DRBs may be separately established.

The following further describes the wireless communication method provided in this embodiment of this application.

To implement a scenario of FL, an application server may connect to one or more base stations through a UPF, and each base station covers a terminal participating in the FL. In an example, as shown in FIG. 13, a group includes 10 terminals: UE 1 to UE 10, where the UE 1 to the UE 3 are distributed under a RAN node 1, the UE 4 and the UE 5 are distributed under the RAN node 2, the UE 6 to the UE 10 are distributed under the RAN node 3, and the UE 1 to the UE 10 perform data transmission with an application server 1302 through the RAN node 1 to the RAN node 3 (namely, base stations) and a UPF 1301. The UPF or a RAN node on the RAN side performs control of aggregate bit rates on the group formed by the 10 terminals. Thus, the following capabilities need to be defined:
1. Each of the 10 terminals establishes a connection to a core network by using a QoS flow of a PDU session, and may perform transmission of application data by using a QoS flow guaranteed with a guaranteed flow bit rate GFBR, or may perform transmission by using a QoS flow with a non-GFBR.
2. A sum of GFBRs corresponding to QoS flows for the terminals in the group to transmit data with the application server may be greater than a value of an AMBR of the group.

For example, the value of the AMBR of the group is 20 Mbps, and a total value of GFBRs of the QoS flows of the 10 terminals may be 50 Mbps or another value greater than 20 Mbps. This aims to enable an application layer to have enough space to adjust a transmission rate of each terminal in each round and implement guarantee by using a 5GS.
3. The UPF or the RAN side performs measurement on an aggregate bit rate of the group, namely, a first rate.

A real-time aggregate bit rate of the group is calculated. Even if the sum of the GFBRs of the 10 terminals may be greater than the AMBR of the group, a real-time (or referred to as “instantaneous”) aggregate bit rate of the 10 terminals in the group that perform data transmission with the application server cannot be greater than the AMBR of the group.

The AMBR of the group may be divided into uplink and downlink, and may be configured in uplink and downlink separately.

If measurement is performed on the RAN side, a single RAN node may obtain a sum of rates of QoS flows of terminals under the RAN node by summing up rates of the QoS flows of the terminals in the group. A plurality of RAN nodes may exchange measurement results through an Xn interface between base stations, so as to sum up rates of QoS flows of terminals in each RAN node to obtain a measurement value of an aggregate bit rate, namely, a real-time aggregate bit rate.
4. When the measurement value of the aggregate bit rate of the group exceeds an upper limit (which may be a predefined AMBR of the group):
   if control is performed by the UPF, the UPF may perform rate limiting on QoS flows of one or more UEs to avoid that the value of the aggregate bit rate of the group exceeds the upper limit; in addition, the UPF may notify an SMF, and the SMF instructs the RAN side to limit rates of QoS flows of one or more terminals, or deactivate (disable) or delete QoS flows of one or more terminals, or the UPF itself instructs the RAN side to limit rates of QoS flows of one or more terminals, or deactivate (disable) or delete QoS flows of one or more terminals, so as to achieve a purpose that the aggregate bit rate of the group does not exceed the upper limit;
   Note: One UE may have a plurality of QoS flows, and only one or more QoS flows may participate in calculation of an aggregate bit rate of a group when transmitting data with QoS flows of another UE;
   if control is performed on the RAN side, a RAN node may perform rate limiting, deactivation, or deletion on DRBs corresponding to one or more QoS flows.

The wireless communication methods provided in embodiments of this application may be implemented as but are not limited to the following embodiments.

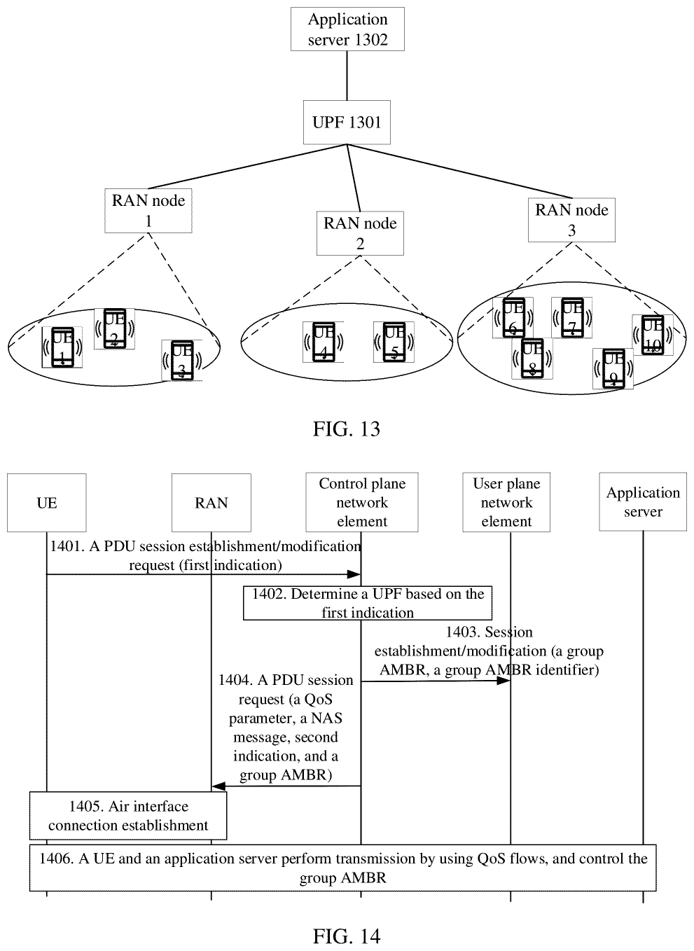

As shown in FIG. 14, a wireless communication method provided in an embodiment of this application includes the following steps.

In S1401, a UE transits a PDU session establishment/modification request to a control plane network element.

The UE adds a first indication, namely, fourth indication information, to the PDU session establishment/modification request, and transmits the PDU session establishment/modification request with the first indication added to the control plane network element. The first indication is used to instruct the UE to join a specific group service (for example, an FL service), and may further indicate a specific group service to which the UE joins.

The control plane network element may be an SMF.

In S1402, the control plane network element determines a user plane network element.

After receiving the PDU session establishment/modification request, the control plane network element determines the user plane network element based on the first indication. All terminals that apply for joining a group of services are served by a same UPF, so that aggregate bit rates of the group may be measured and controlled.

The user plane network element may be a UPF.

In S1403, the control plane network element transmits a PDU session request message to the user plane network element.

The control plane network element may determine a QoS parameter and a QoS rule/data packet detection rule (PDR) of the UE based on the first indication and/or another parameter (for example, a policy and charging control (PCC) rule), and determine a QoS flow that participates in control of an aggregate bit rate (that is, determine a group AMBR applicable to a QoS flow that participates in control of the aggregate bit rate or a group AMBR identifier). The group AMBR, the group AMBR identifier, namely, a first identifier and/or a group service identifier, namely, a second identifier are carried in the PDU session establishment/modification request and transmitted to the user plane network element, so that the user plane network element performs establishment, binding, and/or monitoring and control of the QoS flow.

In S1404, the control plane network element transmits a PDU session request message to an RAN.

The PDU session request message may include a QoS parameter and a NAS message that includes a QoS rule. If monitoring of the aggregate bit rate of the group needs to be performed on an RAN side, when the control plane network element transmits the PDU session request message to the RAN, the PDU session request message carries not only the existing QoS parameter and the NAS message that includes a QoS rule, but also second indication, namely, fifth indication information, a group AMBR, a group AMBR identifier, and/or a group service identifier. The second indication is used for indicating a specific QoS flow, participating in control of an aggregate bit rate, of the terminal. Based on the second indication, the base station may determine a specific QoS flow, participating in control of an aggregate bit rate of a group for the terminal, and the group AMBR, the group AMBR identifier and/or the group service identifier are used for determining a specific value of the group AMBR.

In S1405, a DRB is established between the RAN and the UE.

The base station establishes a DRB through interaction with the terminal to serve different QoS flows of the UE. Herein, if a QoS flow participates in monitoring of the group AMBR, a DRB may be separately established for the QoS flow (even if a QoS parameter of the QoS flow is the same as another QoS flow), which aims to easily manage the DRB.

In S1406, the terminal and an application server perform, by using QoS flows, data transmission of the group service, and control an aggregate bit rate of the group.

Because a plurality of UEs establish, according to S1401 to S1405, QOS flows that participate in control of aggregate bit rates, a 5GS node (a UPF or an RAN) monitors an aggregate bit rate based on a sum of real-time rates for transmitting data by using these QoS flows, namely, a real-time aggregate bit rate, and performs necessary control (for example, a flow limiting measure or the like is taken when a maximum value is exceeded).

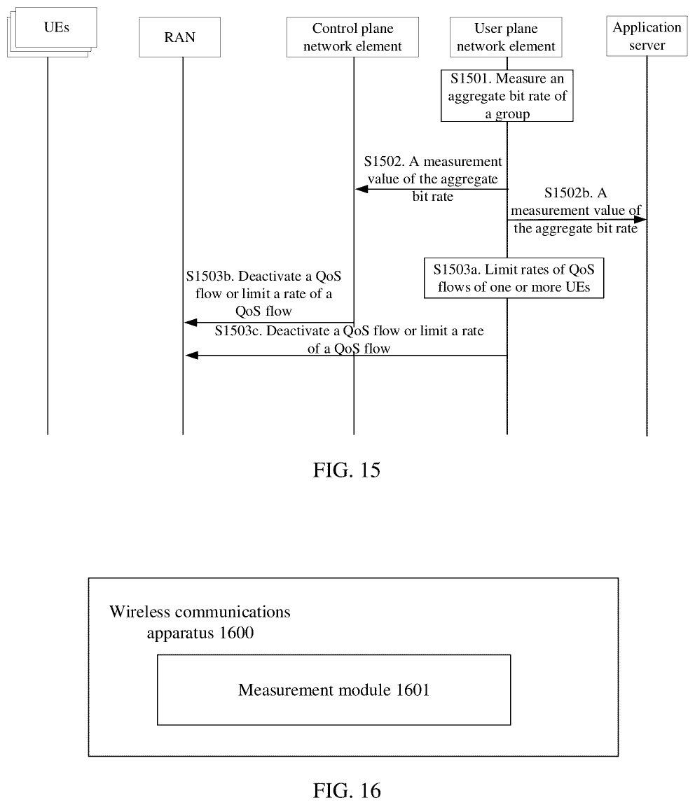

After a PDU session is established, as shown in FIG. 15, the wireless communication method provided in an embodiment of this application includes the following steps.

In S1501, a user plane network element measures an aggregate bit rate of a group.

After starting to monitor the aggregate bit rate of the group, the user plane network element may measure a sum of rates of QoS flows for all UEs in the group to transmit data with an application server to obtain a measurement value of the aggregate bit rate of the group, and when detecting that the measurement value of the aggregate bit rate exceeds a specified value, the user plane network element may perform S1502a and S1502b.

In S1502a, the user plane network element reports the measurement value of the aggregate bit rate to a control plane network element.

In S1502b, the user plane network element reports the measurement value of the aggregate bit rate to the application server.

Through the S1502a and S1502b, the user plane network element reports a measurement result of the aggregate bit rate (including whether the measurement value exceeds a value of an AMBR of the group and/or a measured value of the aggregate bit rate).

To control that an actual value of the aggregate bit rate of the group is within a predetermined range, the user plane network element may perform S1503a or S1503c, or the control plane network element performs S1503b.

In S1503a, the user plane network element limits a rate of QoS flows of one or more UEs.

In S1503b, the control plane network element instructs an RAN to deactivate a QoS flow or limit a rate of a QoS flow.

The control plane network element instructs the RAN to deactivate one or more QoS flows or limit rates of one or more QoS flows of the group. The RAN performs rate limiting on DRBs of the QoS flows of one or more UEs in a group or deactivates one or more QoS flows.

The disabling (or inactivation) of S1503b may be performed for a QoS flow granularity or a PDU session granularity. The disabling is temporarily invalid/deactivated, does not mean that the data stream or session is deleted, and the data stream or session may be automatically resumed when a timer has completed its countdown, or may be resumed by transmitting an enabling or activating (enable/activate) signal to a core network element.

In S1503c, the user plane network element instructs the RAN to deactivate a QoS flow or limit a rate of the QoS flow.

Herein, after S1503a, S1503b, or S1503c, the aggregate bit rate of the group may be limited to an upper limit.

According to the wireless communication method provided in the embodiment of this application, an existing process and architecture of a 5G core network are fully utilized to monitor and control an aggregate bit rate of a group, and an actual rate of a group service for a plurality of UEs may be controlled, which is helpful to ensure normal use of another service by preventing network resources from being excessively occupied by a specific group service.

The wireless communication method provided in the embodiment of this application has the following technical features.
1. The method may not be limited to a 5G network, or may be applied to another network, for example, a 6G network.
2. The method may be applicable to a group service scenario based on group management.
3. A rate upper limit of data flows for a plurality of UEs in a same group may be continuously controlled by using only a 5GS network element (for example, a UPF) without considering a plurality of iterations.
4. A deactivation mechanism may be used separately from a group AMBR scenario, that is, a corresponding QoS flow/PDU session or the like may be deactivated (disable/inactivate) whenever necessary.

The foregoing describes in detail the preferred implementations of this application with reference to the accompanying drawings. However, this application is not limited to specific details in the foregoing implementations. Within a technical concept scope of this application, a plurality of simple variations of the technical solutions of this application may be performed, and these simple variations are all within the protection scope of this application. For example, each specific technical feature described in the foregoing specific implementations may be combined in any suitable manner without contradiction. To avoid unnecessary repetition, various possible combination manners are not described in this application. For another example, any combination may alternatively be performed between different implementations of this application, provided that the combination is not contrary to the idea of this application, and the combination shall also be considered as the content disclosed in this application. For another example, on the premise of no conflict, embodiments described in this application and/or the technical features in embodiments may be randomly combined with the conventional technology, and the technical solutions obtained after the combination also fall within the protection scope of this application.

It should be further understood that, in the method embodiments of this application, sequence numbers of the foregoing processes do not mean execution sequences. The execution sequences of the processes shall be determined based on functions and internal logic of the processes, and shall not be construed as any limitation on the implementation processes of embodiments of this application. In addition, in embodiments of this application, the terms “downlink”, “uplink”, and “sidelink” are used to indicate a transmission direction of a signal or data, where “downlink” indicates that a transmission direction of a signal or data is a first direction from a station to a user equipment in a cell, “uplink” indicates that a transmission direction of a signal or data is a second direction from a user equipment in a cell to a station, and “sidelink” indicates that a transmission direction of a signal or data is a third direction from a user equipment 1 to a user equipment 2. For example, “downlink signal” indicates that a transmission direction of the signal is the first direction. In addition, in embodiments of this application, the term “and/or” is merely used to describe an association relationship between associated objects, and represents that there may be three relationships. Specifically, A and/or B may represent three cases: only A exists, both A and B exist, and only B exists. In addition, the character “/” in this specification generally indicates an “or” relationship between the associated objects.

FIG. 16 is a schematic diagram 1 of a structure of a wireless communications apparatus according to an embodiment of this application, which is applied to a first network device. As shown in FIG. 16, the wireless communications apparatus 1600 includes:
a measurement module 1601, configured to measure a first rate of a first group, where the first group includes at least two terminal devices that participate in a first group service, the first rate is formed by rates of at least two first connections, the at least two first connections include first connections for the at least two terminal devices, and the first connection is used for transmitting data of the first group service.

In some embodiments, the first connection is configured with a guaranteed bit rate GBR. Alternatively, the first connection is not configured with a GBR.

In some embodiments, a sum of GBRs of the at least two first connections is greater than an aggregate maximum bit rate AMBR of the first group.

In some embodiments, an adjustment condition of the first rate includes:
a measurement value of the first rate is greater than a first rate threshold.

In some embodiments, a condition for stopping adjustment of the first rate includes:
a measurement value of the first rate is less than or equal to a first rate threshold.

In some embodiments, an adjustment manner of the first rate includes at least one of the following:
limiting a rate of at least one of the first connections;
limiting a rate of a data radio bearer DRB corresponding to at least one of the first connections;
deactivating at least one of the first connections;
deactivating a DRB corresponding to at least one of the first connections;
deleting at least one of the first connections; or
deleting a DRB corresponding to at least one of the first connections.

In some embodiments, the first network device is a user plane function UPF or a first base station.

In some embodiments, in a case that the first network device is a UPF, the apparatus 1600 further includes:
a first adjustment module, configured to limit a rate of at least one of the first connections.

In some embodiments, in a case that the first network device is a UPF, the apparatus 1600 further includes:
a second adjustment module, configured to transmit, to a second base station, first indication information for indicating at least one of the following:
   limiting a rate of at least one of the first connections served by the second base station;
   deactivating at least one of the first connections served by the second base station; or
   deleting at least one of the first connections served by the second base station.

In some embodiments, in a case that the first network device is a UPF, the apparatus 1600 further includes:
a third adjustment module, configured to transmit, to a second network device, first information for indicating a measurement value of the first rate.

In some embodiments, the first information includes at least one of the following:
the measurement value of the first rate; or
second indication information for indicating that the measurement value of the first rate is greater than a first rate threshold.

In some embodiments, the first information is used for determining third indication information transmitted by the second network device to the second base station, and the third indication information is used for indicating at least one of the following:
limiting a rate of at least one of the first connections served by the second base station;
deactivating at least one of the first connections served by the second base station; or
deleting at least one of the first connections served by the second base station.

In some embodiments, the first rate threshold is an AMBR of the first group.

In some embodiments, the first connection is a protocol data unit PDU session or a quality of service QoS flow.

In some embodiments, in a case that the first network device is a UPF, the apparatus 1600 further includes:
a first receiving module, configured to receive a second message transmitted by a second network device, where the second message includes second information, and the second information is at least used for control of the first rate.

In some embodiments, the second information includes at least one of the following:
a QoS parameter of a first terminal device, where the first terminal device is any one of the terminal devices in the first group;
a QoS rule of a first terminal device;
fifth indication information for indicating a first connection of a first terminal device; or
sixth indication information, where the fifth indication information is used for indicating an AMBR of the first group.

In some embodiments, the sixth indication information includes at least one of the following:
the AMBR;
a first identifier for indicating the AMBR; or
a second identifier of the first group service.

In some embodiments, the second message is used for establishing or updating a PDU session.

In some embodiments, the first connection corresponds to an independent DRB.

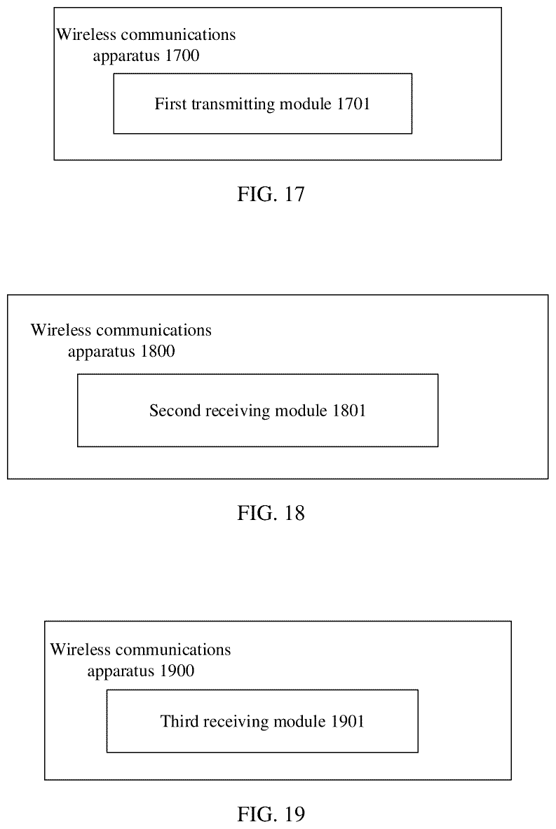

FIG. 17 is a schematic diagram 1 of a structure of a wireless communications apparatus according to an embodiment of this application, which is applied to a first terminal device. As shown in FIG. 17, the wireless communications apparatus 1700 includes:
a first transmitting module 1701, configured to transmit a first message to a second network device, where the first message carries fourth indication information, the fourth indication information is used for instructing the first terminal device to join a first group and/or participate in a first group service, and the first group includes at least two terminal devices that participate in the first group service.

In some embodiments, the first message is used for establishing or updating a PDU session.

In some embodiments, the fourth indication information is at least used for the second network device to determine a third network device.

In some embodiments, the third network device serves at least two terminal devices in the first group.

In some embodiments, the fourth indication information is at least used for determining second information, the second information is at least used for control of a first rate, the first rate is formed by rates of at least two first connections, the at least two first connections include first connections for the at least two terminal devices, and the first connection is used for transmitting data of the first group service.

In some embodiments, the second information includes at least one of the following:
a quality of service QoS parameter of the first terminal device;
a QoS rule of a first terminal device;
fifth indication information for indicating a first connection of the first terminal device; or
sixth indication information for indicating an AMBR of the first group.

In some embodiments, the sixth indication information includes at least one of the following:
the AMBR;
a first identifier for indicating the AMBR; or
a second identifier of the first group service.

In some embodiments, the first connection is a PDU session or a quality of service QoS flow.

In some embodiments, the first connection corresponds to an independent data radio bearer DRB.

FIG. 18 is a schematic diagram of a structure of a wireless communications apparatus according to an embodiment of this application, which is applied to a second network device. As shown in FIG. 18, the wireless communications apparatus 1800 includes:
a second receiving module 1801, configured to receive a first message transmitted by a first terminal device, where the first message carries fourth indication information, the fourth indication information is used for instructing the first terminal device to join a first group and/or participate in a first group service, and the first group includes at least two terminal devices that participate in the first group service.

In some embodiments, the first message is used for establishing or updating a PDU session.

In some embodiments, the fourth indication information is used for the second network device to determine a third network device.

In some embodiments, the third network device serves at least two terminal devices in the first group.

In some embodiments, the fourth indication information is further used for determining second information, the second information is at least used for control of a first rate, the first rate is formed by rates of at least two first connections, the at least two first connections include first connections for the at least two terminal devices, and the first connection is used for transmitting data of the first group service.

In some embodiments, the apparatus 1800 further includes:
a second transmitting module, configured to transmit a second message to a third network device, where the second message includes second information, the second information is at least used for control of a first rate, the first rate is formed by rates of at least two first connections, the at least two first connections include first connections for the at least two terminal devices, and the first connection is used for transmitting data of the first group service.

In some embodiments, the second message is used for establishing or updating a PDU session.

In some embodiments, the second information includes at least one of the following:
a quality of service QoS parameter of the first terminal device;
a QoS rule of a first terminal device;
fifth indication information for indicating a first connection of the first terminal device; or
sixth indication information for indicating an AMBR of the first group.

In some embodiments, the apparatus 1800 further includes:
a third transmitting module, configured to transmit a third message to a first base station, where the third message includes third information, and the third information is at least used for QoS control.

In some embodiments, the third information includes at least one of the following:
a quality of service QoS parameter of the first terminal device; or
a QoS rule of the first terminal device.

In some embodiments, the third information is further used for instructing the first base station to control a first rate, the first rate is formed by rates of at least two first connections, the at least two first connections include first connections for the at least two terminal devices, and the first connection is used for transmitting data of the first group service.

In some embodiments, the third information includes at least one of the following:
fifth indication information for indicating a first connection of the first terminal device;
sixth indication information for indicating an AMBR of the first group; or
seventh indication information for instructing the first base station to control the first rate.

In some embodiments, the sixth indication information includes at least one of the following:
the AMBR;
a first identifier for indicating the AMBR; or
a second identifier of the first group service.

In some embodiments, the first connection is a PDU session or a quality of service QoS flow.

In some embodiments, the first connection corresponds to an independent data radio bearer DRB.

FIG. 19 is a schematic diagram of a structure of a wireless communications apparatus according to an embodiment of this application, which is applied to a third network device. As shown in FIG. 19, the communications apparatus 1900 includes:
a third receiving module 1901, configured to receive a second message transmitted by a second network device, where the second message includes second information, the second information is at least used for control of a first rate, the first rate is formed by rates of at least two first connections, the at least two first connections include first connections for the at least two terminal devices in a first group, the first group includes at least two terminal devices that participate in a first group service, and the first connection is used for transmitting data of the first group service.

In some embodiments, the second information includes at least one of the following:
a QoS parameter of a first terminal device, where the first terminal device is any one of the terminal devices in the first group;
a QoS rule of a first terminal device;
fifth indication information for indicating a first connection of a first terminal device; or
sixth indication information for indicating an AMBR of the first group.

In some embodiments, the sixth indication information includes at least one of the following:
the AMBR;
a first identifier for indicating the AMBR; or
a second identifier of the first group service.

In some embodiments, the second message is used for establishing or updating a PDU session.

In some embodiments, the first connection is a PDU session or a quality of service QoS flow.

In some embodiments, the first connection corresponds to an independent DRB.

A person skilled in the art should understand that related descriptions of the foregoing wireless communications apparatuses in embodiments of this application may be understood with reference to related descriptions of the wireless communication methods in embodiments of this application.

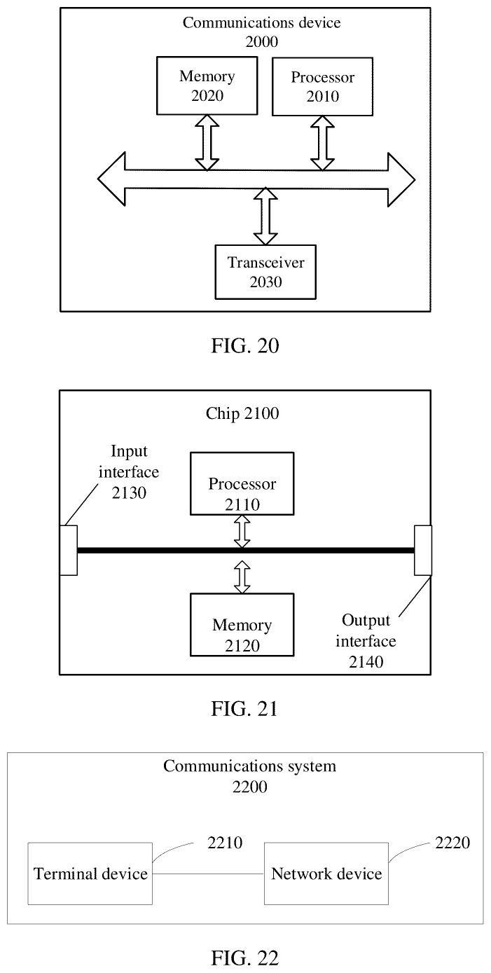

FIG. 20 is a schematic structural diagram of a communications device 2000 according to an embodiment of this application. The communications device may be a terminal device, or may be a first network device, a second network device, or a third network device. The communications device 2000 shown in FIG. 20 includes a processor 2010, and the processor 2010 may invoke a computer program from a memory and run the computer program to implement the method in embodiments of this application.

Optionally, as shown in FIG. 20, the communications device 2000 may further include a memory 2020. The processor 2010 may invoke a computer program from the memory 2020 and run the computer program to implement the method in embodiments of this application.

The memory 2020 may be a separate component independent of the processor 2010, or may be integrated into the processor 2010.

Optionally, as shown in FIG. 20, the communications device 2000 may further include a transceiver 2030. The processor 2010 may control the transceiver 2030 to communicate with another device, and specifically, may send information or data to the another device, or receive information or data sent by the another device.

The transceiver 2030 may include a transmitter and a receiver. The transceiver 2030 may further include an antenna, and the number of antennas may be one or more.

Optionally, the communications device 2000 may be specifically a network device in embodiments of this application, and the communications device 2000 may implement corresponding procedures implemented by the network device in methods in embodiments of this application. For brevity, details are not described herein again.

Optionally, the communications device 2000 may be specifically a mobile terminal/terminal device in embodiments of this application, and the communications device 2000 may implement corresponding procedures implemented by the mobile terminal/the terminal device in methods in embodiments of this application. For brevity, details are not described herein again.

FIG. 21 is a schematic structural diagram of a chip according to an embodiment of this application. A chip 2100 shown in FIG. 21 includes a processor 2110, and the processor 2110 may invoke a computer program from a memory and run the computer program to implement the method in embodiments of this application.

Optionally, as shown in FIG. 21, the chip 2100 may further include a memory 2120. The processor 2110 may invoke a computer program from the memory 2120 and run the computer program to implement a method in embodiments of this application.

The memory 2120 may be a separate component independent of the processor 2110, or may be integrated into the processor 2110.

Optionally, the chip 2100 may further include an input interface 2130. The processor 2110 may control the input interface 2130 to communicate with another device or chip, and specifically, may obtain information or data sent by the another device or chip.

Optionally, the chip 2100 may further include an output interface 2140. The processor 2110 may control the output interface 2140 to communicate with another device or chip, and specifically, may output information or data to the another device or chip.

Optionally, the chip may be applied to the network device in embodiments of this application, and the chip may implement corresponding processes implemented by the network device in methods in embodiments of this application. For brevity, details are not described herein again.

Optionally, the chip may be applied to the mobile terminal/terminal device in embodiments of this application, and the chip may implement corresponding processes implemented by the mobile terminal/terminal device in methods in embodiments of this application. For brevity, details are not described herein again.

It should be understood that the chip mentioned in this embodiment of this application may also be referred to as a system-level chip, a system chip, a chip system, a system-on-chip, or the like.

FIG. 22 is a schematic block diagram of a communications system 2200 according to an embodiment of this application. As shown in FIG. 22, the communications system 2200 includes a terminal device 2210 and a network device 2220.

The terminal device 2210 may be used to implement the corresponding functions implemented by the terminal device in the foregoing methods, and the network device 1420 may be used to implement the corresponding functions implemented by the first network device, the second network device, or the third network device in the foregoing methods. For brevity, details are not described herein again.

It should be understood that, a processor in the embodiment of this application may be an integrated circuit chip having a signal processing capability. In an implementation process, the steps in foregoing method embodiments may be performed by using an integrated logic circuit of hardware of the processor or instructions in a software form. The processor may be a general-purpose processor, a digital signal processor (DSP), an application-specific integrated circuit (ASIC), a field programmable gate array (FPGA) or another programmable logic device, a discrete gate or a transistor logic device, or a discrete hardware component. The processor may implement or execute the methods, steps, and logical block diagrams disclosed in embodiments of this application. The general-purpose processor may be a microprocessor, or the processor may be any conventional processor or the like. The steps of methods disclosed with reference to embodiments of this application may be directly implemented by a hardware decoding processor, or may be implemented by a combination of hardware and software modules in a decoding processor. The software module may be located in a mature storage medium in the art, for example, a random access memory, a flash memory, a read-only memory, a programmable read-only memory, an erasable programmable memory, or a register. The storage medium is located in a memory. The processor reads information from the memory, and performs the steps of foregoing methods in combination with hardware of the processor.

It may be understood that the memory in embodiments of this application may be a volatile memory or a non-volatile memory, or may include both a volatile memory and a non-volatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), and is used as an external cache. By way of example but not limitative description, many forms of RAMs may be used, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchlink dynamic random access memory (Synchlink DRAM, SLDRAM), and a direct Rambus random access memory (Direct Rambus RAM, DR RAM). It should be noted that, the memory in the systems and methods described in this specification includes but is not limited to these memories and any memory of another proper type.

It should be understood that, by way of example but not limitative description, for example, the memory in this embodiment of this application may alternatively be a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synch link DRAM, SLDRAM), a direct Rambus random access memory (Direct Rambus RAM, DR RAM), or the like. In other words, the memory in embodiments of this application includes but is not limited to these memories and any memory of another proper type.

An embodiment of this application further provides a computer-readable storage medium, configured to store a computer program.

Optionally, the computer-readable storage medium may be applied to a network device in embodiments of this application, and the computer program causes a computer to execute corresponding procedures implemented by the network device in methods in embodiments of this application. For brevity, details are not described herein again.

Optionally, the computer-readable storage medium may be applied to a mobile terminal/terminal device in embodiments of this application, and the computer program causes a computer to execute corresponding procedures implemented by the mobile terminal/terminal device in methods in embodiments of this application. For brevity, details are not described herein.

An embodiment of this application further provides a computer program product, including computer program instructions.

Optionally, the computer program product may be applied to a network device in embodiments of this application, and the computer program instructions cause a computer to execute corresponding procedures implemented by the network device in methods in embodiments of this application. For brevity, details are not described herein again.

Optionally, the computer program product may be applied to a mobile terminal/terminal device in embodiments of this application, and the computer program instructions cause a computer to execute corresponding procedures implemented by the mobile terminal/terminal device in methods in embodiments of this application. For brevity, details are not described herein again.

An embodiment of this application further provides a computer program.

Optionally, the computer program may be applied to a network device in embodiments of this application. When the computer program runs on a computer, the computer executes corresponding procedures implemented by the network device in methods in embodiments of this application. For brevity, details are not described herein again.

Optionally, the computer program may be applied to a mobile terminal or a terminal device in embodiments of this application. When the computer program runs on a computer, the computer executes corresponding procedures implemented by the mobile terminal or the terminal device in methods in embodiments of this application. For brevity, details are not described herein again.

A person of ordinary skill in the art may be aware that, units and algorithm steps in examples described in combination with embodiments disclosed in this specification can be implemented by electronic hardware or a combination of computer software and electronic hardware. Whether the functions are executed by hardware or software depends on particular applications and design constraints of the technical solutions. A person skilled in the art may use different methods to implement the described functions for each particular application, but it should not be considered that the implementation goes beyond the scope of this application.

Those skilled in the art may clearly understand that, for the purpose of convenient and brief description, for detailed working processes of the foregoing system, apparatus, and unit, reference may be made to the corresponding processes in the foregoing method embodiments, and details are not described herein again.

In the several embodiments provided in this application, it should be understood that the disclosed system, apparatus, and method may be implemented in another manner. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between apparatuses or units may be implemented in electrical, mechanical, or other forms.

The units described as separate components may be or may not be physically separated, and the components displayed as units may be or may not be physical units, that is, may be located in one place or distributed on a plurality of network units. Some or all of the units may be selected according to actual needs to achieve the objective of the solutions of the embodiments.

In addition, functional units in embodiments of this application may be integrated into one processing unit, or each of the units may exist alone physically, or two or more units may be integrated into one unit.

When the functions are implemented in a form of a software function unit and sold or used as an independent product, the functions may be stored in a computer-readable storage medium. Based on such an understanding, the technical solutions in this application essentially, or the part contributing to the prior art, or some of the technical solutions may be implemented in a form of a software product. The computer software product is stored in a storage medium and includes several instructions for instructing a computer device (which may be a personal computer, a server, a network device, or the like) to execute all or some of the steps of the methods in embodiments of this application. The foregoing storage medium includes any medium that can store program code, such as a USB flash drive, a removable hard disk, a read-only memory (ROM), a random access memory (RAM), a magnetic disk, or an optical disk.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application should be subject to the protection scope of the claims.

1. A wireless communication method, wherein the method comprises:
measuring, by a first network device, a first rate of a first group, wherein the first group comprises at least two terminal devices, the first rate is formed by rates of at least two first connections, and the first connection is used for transmitting data of a first group service.

2. The method according to claim 1, wherein the at least two first connections comprise first connections for the at least two terminal devices.

3. The method according to claim 1, wherein the first connection is a protocol data unit (PDU) session or a (quality of service) QoS flow.

4. The method according to claim 1, wherein the first group service is federated learning (FL).

5. The method according to claim 1, wherein the measuring, by a first network device, a first rate of a first group comprises:
measuring rates of the first connections for the at least two terminal devices in the first group and adding measurement results of the at least two first connections, to obtain a measurement value of the first rate.

6. The method according to claim 1, wherein
the first connection is configured with a guaranteed bit rate (GBR); or
the first connection is not configured with a GBR.

7. The method according to claim 1, wherein a sum of GBRs of the at least two first connections is greater than an aggregate maximum bit rate (AMBR) of the first group.

8. The method according to claim 5, wherein the method further comprises:
transmitting, by the first network device, first information to a second network device, when the measurement value of the first rate is greater than a first rate threshold, wherein the first information is used for indicating the measurement value of the first rate.

9. The method according to claim 1, wherein an adjustment manner of the first rate comprises at least one of following:
limiting a rate of at least one of the first connections;
limiting a rate of a (data radio bearer) DRB corresponding to at least one of the first connections;
deactivating at least one of the first connections;
deactivating a DRB corresponding to at least one of the first connections;
deleting at least one of the first connections; or
deleting a DRB corresponding to at least one of the first connections.

10. The method according to claim 1, wherein the first network device is a user plane function network element (UPF) or a first base station.

11. A first network device, comprising a processor and a memory, wherein the memory is configured to store a computer program, and the processor is configured to invoke and run the computer program stored in the memory to cause the first network device to perform:
measuring a first rate of a first group, wherein the first group comprises at least two terminal devices, the first rate is formed by rates of at least two first connections, and the first connection is used for transmitting data of a first group service.

12. The first network device according to claim 11, wherein the at least two first connections comprise first connections for the at least two terminal devices.

13. The first network device according to claim 11, wherein the first connection is a protocol data unit (PDU) session or a (quality of service) QoS flow.

14. The first network device according to claim 11, wherein the first group service is federated learning (FL).

15. The first network device according to claim 11, wherein the processor is configured to invoke and run the computer program stored in the memory to cause the first network device to further perform:
measuring rates of the first connections for the at least two terminal devices in the first group and adding measurement results of the at least two first connections, to obtain a measurement value of the first rate.

16. The first network device according to claim 11, wherein
the first connection is configured with a guaranteed bit rate (GBR); or
the first connection is not configured with a GBR.

17. The first network device according to claim 11, wherein a sum of GBRs of the at least two first connections is greater than an aggregate maximum bit rate (AMBR) of the first group.

18. The first network device according to claim 15, wherein the processor is configured to invoke and run the computer program stored in the memory to cause the first network device to further perform:
transmitting first information to a second network device when the measurement value of the first rate is greater than a first rate threshold, wherein the first information is used for indicating the measurement value of the first rate.

19. The first network device according to claim 11, wherein an adjustment manner of the first rate comprises at least one of following:
limiting a rate of at least one of the first connections;
limiting a rate of a (data radio bearer) DRB corresponding to at least one of the first connections;
deactivating at least one of the first connections;
deactivating a DRB corresponding to at least one of the first connections;
deleting at least one of the first connections; or
deleting a DRB corresponding to at least one of the first connections.

20. The first network device according to claim 11, wherein the first network device is a user plane function network element (UPF) or a first base station.
